(19) United States
(12) Patent Application Publication
(10) Pub. No.: US 2017/0093634 A1
(43) Pub. Date: Mar. 30, 2017

(54) SERVICE PROVIDING APPARATUS, SERVICE PROVIDING METHOD, AND NON-TRANSITORY COMPUTER READABLE MEDIUM

(71) Applicant: FUJI XEROX CO., LTD., Tokyo (JP)

(72) Inventor: Takashi MOMMA, Kanagawa (JP)

(73) Assignee: FUJI XEROX CO., LTD., Tokyo (JP)

(21) Appl. No.: 14/994,699

(22) Filed: Jan. 13, 2016

(30) Foreign Application Priority Data
Sep. 25, 2015 (JP) 2015-188128

(51) Int. Cl. H04L 12/24

(52) U.S. Cl. CPC H04L 41/0823

(57) ABSTRACT

A service providing apparatus includes a generator and a controller. The generator generates service setting information. The service setting information includes one or more applications that perform environment setting for a service selected by a user, an item to be set by each of the one or more applications for the environment setting of the service among items configurable by the application, and a setting order in which the one or more applications perform setting. The controller controls display of a setting screen for the environment setting performed by the application in accordance with content set in the service setting information.

### CROSS-REFERENCE TO RELATED APPLICATIONS

This application is based on and claims priority under 35 USC 119 from Japanese Patent Application No. 2015-188128 filed Sep. 25, 2015.

### BACKGROUND

(i) Technical Field

The present invention relates to a service providing apparatus, a service providing method, and a non-transitory computer readable medium.

(ii) Related Art

A setup wizard allows users to easily perform environment setting to enable devices to provide services by executing applications. A user enters information about items required by the setup wizard to perform environment setting.

In some cases, services to be loaded into devices may differ depending on customers' needs, and items for specifications and other requirements to be set for each service may also differ. For example, a service A for transmitting an email requires specification settings for a Simple Mail Transfer Protocol (SMTP) server and personal settings such as an email address. A service B for both email transmission and Server Message Block (SMB) storage further requires personal settings of an SMB storage destination. If the same setup wizard is used for the service A and the service B, which are implemented by the same service application, a user who performs environment setting for the service A may be requested to also complete personal settings of the SMB storage destination. To address this situation, a setup wizard corresponding to setting items for each individual service will be needed; the development of individual setup wizards for a large number of services involves high development and management costs.

### SUMMARY

According to an aspect of the invention, there is provided a service providing apparatus including a generator and a controller. The generator generates service setting information. The service setting information includes one or more applications that perform environment setting for a service selected by a user, an item to be set by each of the one or more applications for the environment setting of the service among items configurable by the application, and a setting order in which the one or more applications perform setting. The controller controls display of a setting screen for the environment setting performed by the application in accordance with content set in the service setting information.

### BRIEF DESCRIPTION OF THE DRAWINGS

An exemplary embodiment of the present invention will be described in detail based on the following figures, wherein:

FIG. 1 is a block configuration diagram illustrating a service providing apparatus according to an exemplary embodiment of the present invention;

FIG. 2 is a hardware configuration diagram of a computer that constitutes the service providing apparatus according to this exemplary embodiment;

FIG. 3 illustrates an example data configuration of common application information stored in a common application (“app”) information storage unit according to this exemplary embodiment;

FIG. 4 illustrates an example of a setting screen according to this exemplary embodiment;

FIG. 5 illustrates an example data configuration of service setting information registered in a service setting information storage unit according to this exemplary embodiment;

FIG. 6 is a flowchart illustrating an environment setting process for a service application according to this exemplary embodiment;

FIG. 7 illustrates an example of parameters set in service setting information edited by using a common app in this exemplary embodiment;

FIG. 8 illustrates an example of parameters set in service setting information obtained by further editing the service setting information illustrated in FIG. 7 by using a common app;

FIG. 9 illustrates another example of parameters set in service setting information in this exemplary embodiment;

FIG. 10 illustrates another example of parameters set in service setting information obtained by editing the service setting information illustrated in FIG. 9 by using a common app;

FIG. 11 illustrates an example of an operator change instruction screen according to this exemplary embodiment; and

FIG. 12 illustrates another example of parameters set in service setting information edited by using a common app in this exemplary embodiment.

### DETAILED DESCRIPTION

An exemplary embodiment of the present invention will be described hereinafter with reference to the drawings.

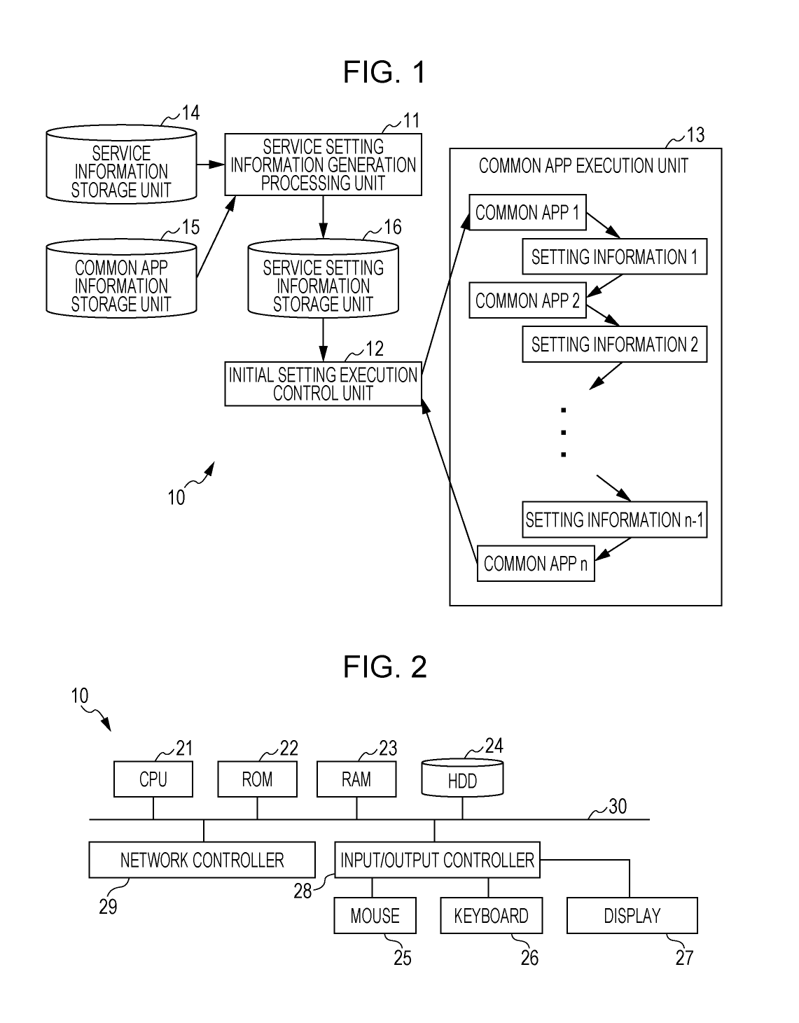

FIG. 1 is a block configuration diagram illustrating a service providing apparatus 10 according to an exemplary embodiment of the present invention. FIG. 2 is a hardware configuration diagram of a computer that constitutes the service providing apparatus 10 according to this exemplary embodiment. In this exemplary embodiment, the computer that constitutes the service providing apparatus 10 is implementable by an existing general-purpose hardware configuration such as a personal computer (PC). That is, as illustrated in FIG. 2, the computer includes a central processing unit (CPU) 21, a read-only memory (ROM) 22, a random access memory (RAM) 23, a hard disk drive (HDD) 24, a mouse 25, a keyboard 26, a display 27, an input/output controller 28, and a network controller 29 serving as a communication unit. The mouse 25 and the keyboard 26 are provided as an input unit, and the display 27 is provided as a display device. The input/output controller 28 connects the mouse 25, the keyboard 26, and the display 27 to one another. The CPU 21, the ROM 22, the RAM 23, the HDD 24, the input/output controller 28, and the network controller 29 are connected to one another via an internal bus 30.

Referring back to FIG. 1, the service providing apparatus 10 according to this exemplary embodiment includes a service setting information generation processing unit 11, an initial setting execution control unit 12, a common application (“app”) execution unit 13, a service information storage unit 14, a common app information storage unit 15, and a service setting information storage unit 16. The service setting information generation processing unit 11 generates service setting information and stores the service setting information in the service setting information storage unit 16. The service setting information is information for configuring a setup wizard customized for a service for which environment setting is to be performed.

A service provided by the service providing apparatus 10 is, for example, a process executed by the service providing apparatus 10 in response to a user request or a process executed by another device (not illustrated) in response to a request made to the other device by the service providing apparatus 10. Any process executable by an apparatus or a device, such as transmitting an email, transmitting an image obtained by reading a paper document to a server, or applying a certain editing process to a document, may be provided as a service.

In this exemplary embodiment, a shared or common application (also referred to as a “common app”) is provided for a setting item which is commonly configured for plural service applications, such as an application for setting specification information and an application for setting personal information on an individual user. A setup wizard performs environment setting for a service application by the execution of shared applications for configuring the setting of setting items necessary for the environment setting of the service application. The initial setting execution control unit 12 starts the execution of a setup wizard for a service application in accordance with the generated service setting information, and causes the execution of shared applications to perform the initial setting (or environment setting) of a service for which environment setting is to be performed. The common app execution unit 13 executes the shared applications. Each common application performs display control of a setting screen for prompting a user to enter an item to be set, and performs the setting of the entered item in accordance with the item. The service information storage unit 14 stores information regarding services available by the service providing apparatus 10.

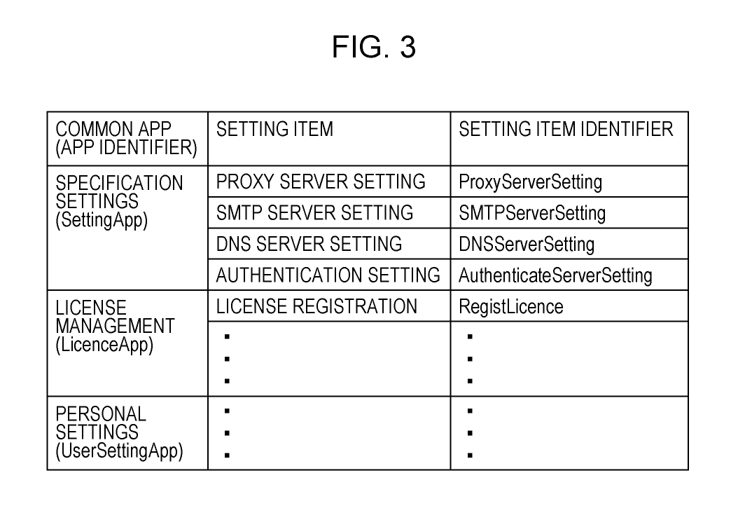

FIG. 3 illustrates an example data configuration of common application information stored in the common app information storage unit 15 according to this exemplary embodiment. The common application information includes preset information regarding common applications prepared in the service providing apparatus 10. The common application information includes, in association with the name of each common app and an app identifier identifying the common app, items configurable by the common app and setting item identifiers each identifying one of the items.

In the service providing apparatus 10, the service setting information generation processing unit 11, the initial setting execution control unit 12, and the common app execution unit 13 are implemented by the cooperative operation of the computer that constitutes the service providing apparatus 10 and a program operating on the CPU 21 in the computer. Each of the storage units 14 to 16 is implemented by the HDD 24 included in the service providing apparatus 10. Alternatively, each of the storage units 14 to 16 may be implemented by the RAM 23 or an external memory or storage unit used via a network.

In addition, a program used in this exemplary embodiment may be provided through a communication unit or may be provided by being stored in a computer-readable recording medium such as a compact disc read-only memory (CD-ROM) or a Universal Serial Bus (USB) memory. A program provided through a communication unit or a recording medium is installed in a computer, and a CPU of the computer sequentially executes the program to implement various processes.

Next, operations in this exemplary embodiment will be described. Processes according to this exemplary embodiment are roughly separated into a process for generating service setting information in preparation for the environment setting of a service application, and a process for executing a setup wizard in accordance with the content set in the generated service setting information to perform the initial setting of the service application. First, a description will be given of the process for generating service setting information.

In accordance with a predetermined operation performed by a user, the service setting information generation processing unit 11 reads the names of services from the service information storage unit 14, and displays a list of the services on a menu screen (not illustrated). When the user selects a service for which environment setting is to be performed from among the displayed services, the service setting information generation processing unit 11 displays a setting screen for service setting information.

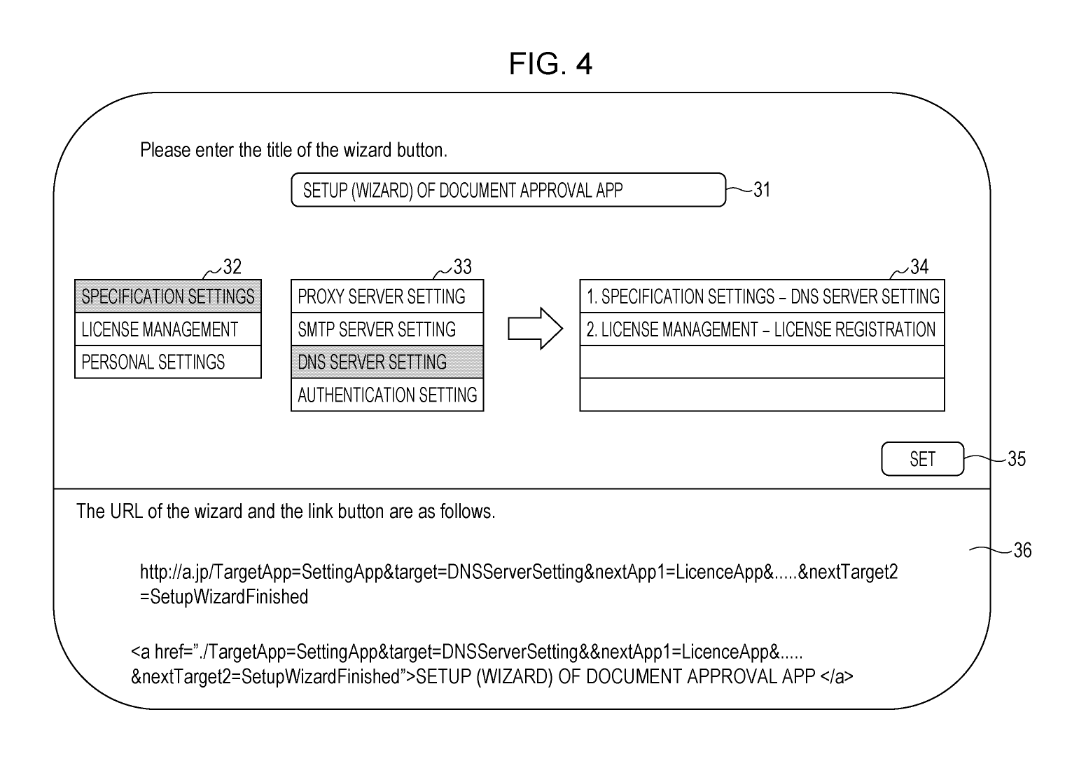

FIG. 4 illustrates an example of a setting screen according to this exemplary embodiment. The user enters a title to be assigned to a wizard button into a title input area 31 on the setting screen. The wizard button is a user interface component for starting a setup wizard for the environment setting of the selected service application. The service setting information generation processing unit 11, when displaying the setting screen, displays the names of common apps registered in the common app information storage unit 15 in a common app list display area 32 in list form. The user selects a common app to be used for the environment setting of the desired service application (in the illustrated example, a “document approval app”) from among the displayed common apps. In the example display illustrated in FIG. 4, a specification setting app is being selected, by way of example. When the specification setting app is selected, the service setting information generation processing unit 11 reads the names of setting items registered in association with this common app from the common app information storage unit 15, and displays the names of the setting items in a setting item display area 33 in list form.

Then, in response to a predetermined confirmation operation, the service setting information generation processing unit 11 registers a pair including the selected common app and setting item in a service setting information display area 34. By repeating the process described above, the service setting information generation processing unit 11 sets pairs including common apps used for the environment setting of the desired service application and setting items to be set for the environment setting of the service application among items configurable by the common app. In the setting of the pairs, multiple setting items may be selected for each common app. Even in this case, one record is set so that common apps and setting items are associated with each other on a one-to-one basis. In the service setting information display area 34, furthermore, the setting order of the common apps is also set. The order in which numbers are listed in the service setting information display area 34 corresponds to the setting order (the order in which the common apps are executed).

After setting pairs each including a common app and a setting item in the service setting information display area 34, the user selects a “Set” button 35 to confirm the setting. In response to the confirmation operation, the service setting information generation processing unit 11 generates service setting information and stores the service setting information in the service setting information storage unit 16.

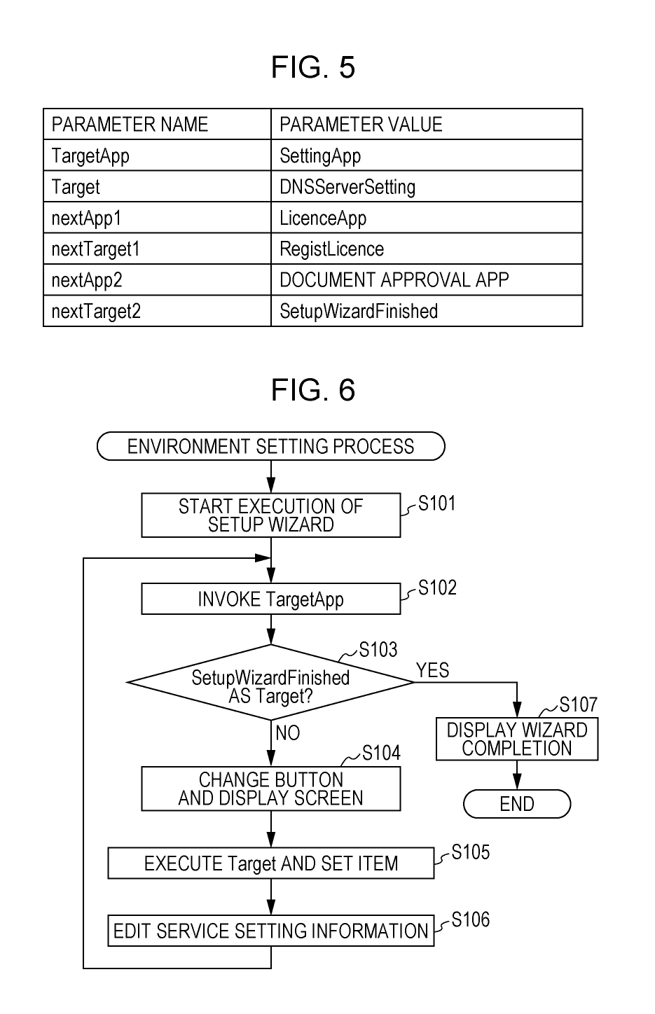

FIG. 5 illustrates an example data configuration of service setting information registered in the service setting information storage unit 16 according to this exemplary embodiment. The service setting information is generated in the following way in accordance with the setting order set in the service setting information display area 34. First, the app identifier “SettingApp” of the common app in the first pair is set as the parameter value of the parameter name “TargetApp”, and the setting item identifier “DNSserverSetting” of the setting item in the first pair is set as the parameter value of the parameter name “Target”. Then, the app identifier “LicenceApp” of the common app in the second pair is set as the parameter value of the parameter name “nextApp1”, and the setting item identifier “RegistLicence” of the setting item in the second pair is set as the parameter value of the parameter name “nextTarget1”. The setting described above is repeatedly performed. When no further pair has been registered in the service setting information display area 34, the service application identifier “document approval app” is set as the parameter value of the parameter name (in the illustrated example, “nextApp2”) and the parameter value “SetupWizardFinished” indicating the completion of the execution of the last common app is set as the parameter value of the parameter name (in the illustrated example, “nextTarget2”) in order to finally return the process to the service application for which environment setting is to be performed.

In the way described above, the service setting information generation processing unit 11 generates service setting information in accordance with the settings defined in the service setting information display area 34. Further, the service setting information generation processing unit 11 generates a URL and tags for a link button for executing the setup wizard for the “document approval app” for which environment setting is to be performed, in accordance with the generated service setting information, and displays the URL and the tags in a predetermined display area 36.

Then, the user accesses the generated URL or selects the link button on a certain page to start the execution of the setup wizard by using the initial setting execution control unit 12. An environment setting process for a service application according to this exemplary embodiment, which is performed by the execution of a setup wizard, will now be described with reference to a flowchart illustrated in FIG. 6.

In the foregoing description, the service setting information illustrated in FIG. 5 is generated prior to the generation of a URL and the like. Alternatively, a URL and the like may be generated first and then the parameters of the URL and the like may be referenced to generate service setting information in a table format.

The initial setting execution control unit 12 starts the execution of a setup wizard to start the initial setting of a service application (in the illustrated example, the “document approval app”) (step S101). The initial setting execution control unit 12 first refers to the content set in the service setting information, and invokes a specification setting app whose application identifier is “SettingApp”, which is set in the parameter name “TargetApp”, from the common apps (step S102). The common app execution unit 13 thus starts the execution of the invoked specification setting app (corresponding to “common app 1” in FIG. 1).

The specification setting app refers to the parameter value of the parameter name “Target” in the service setting information. In the example illustrated in FIG. 5, “DNSserverSetting” is set, which is not “SetupWizardFinished” (NO in step S103), and thus a DNS server setting whose setting item identifier is “DNSserverSetting” within the specification setting app is executed. The DNS server setting requests the user to enter item values such as an Internet protocol (IP) address and a server name. Then, the specification setting app checks the presence of the next pair of parameter names “nextAppl” and “nextTargetl” in the service setting information, and changes a “Confirm” button to be displayed on a setting screen for the environment setting performed by the setup wizard (i.e., a setting screen for the DNS server setting) to a “Confirm and Go Next” button before displaying the setting screen (step S104). In accordance with the request, the user enters the respective item values into input fields on the initial setting screen.

The specification setting app receives and checks the entered item values, sets the item values to the corresponding items, and completes the execution of the DNS server setting (step S105).

When the user selects the “Confirm and Go Next” button, the specification setting app edits the service setting information in the following way (step S106).

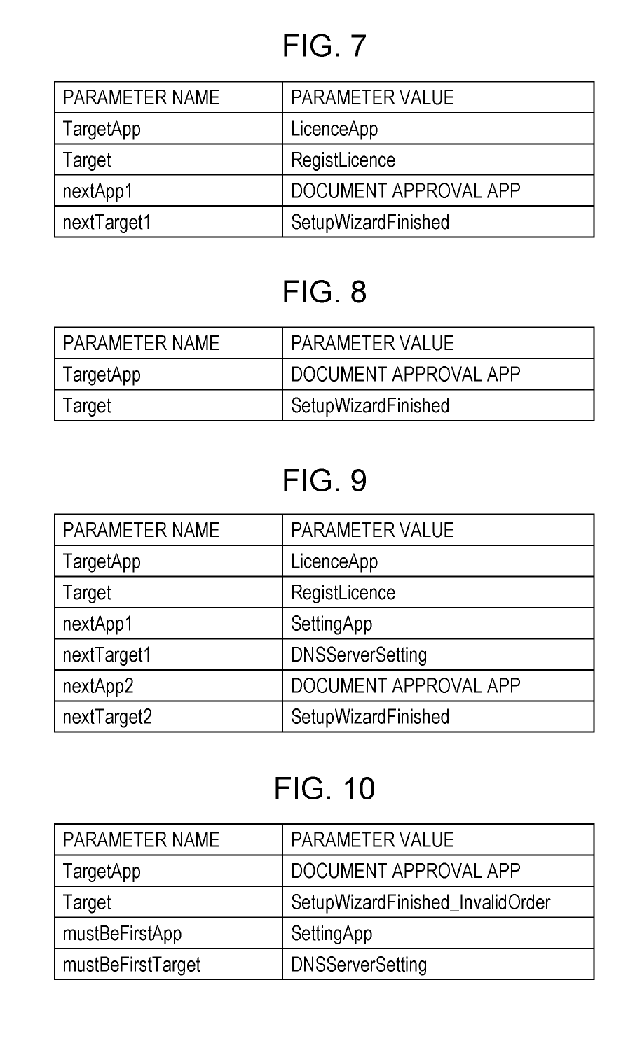

First, the specification setting app deletes information thereon for which the execution has been completed, which is set in “TargetApp” and “Target”, and moves the subsequent parameter values up. That is, as illustrated in FIG. 7, the app identifier “LicenceApp” of the common app registered in the second row of the service setting information display area 34 illustrated in FIG. 4 is set as the parameter value of the parameter name “TargetApp”, and the setting item identifier “RegistLicence” of the setting item registered in the second row of the service setting information display area 34 is set as the parameter value of the parameter name “Target”. In addition, the identifier “document approval app” of the service application is set as the parameter value of the parameter name “nextApp1”, and the parameter value “SetupWizardFinished” is set as the parameter value of the parameter name “nextTarget1”.

Thereafter, the process returns to step S102, and the subsequent process is performed in a way similar to that described above. That is, the specification setting app invokes a license management app whose app identifier is “LicenceApp”, which is set in the parameter name “TargetApp” (step S102).

Since the parameter value of the parameter name “Target” in the service setting information is “RegistLicence” (NO in step S103), the license management app executes license registration whose setting item identifier is “RegistLicence” within the license management app. The license registration requests the user to enter item values such as a license number. The license management app checks the presence of the next pair of parameter names “nextApp1” and “nextTarget1” in the service setting information, and changes a “Complete Registration” button to be displayed on a setting screen for the environment setting performed by the setup wizard (i.e., a setting screen for the license registration) to a “Complete Registration and Go Next” button before displaying the setting screen (step S104). In accordance with the request, the user enters the respective item values into input fields on the initial setting screen.

The license management app receives and checks the entered item values, sets the item values to the corresponding items, and completes the execution of the license registration (step S105).

When the user selects the “Complete Registration and Go Next” button, the license management app edits the service setting information in a way similar to that described above (step S106). That is, the license management app deletes information thereon for which the execution has been completed, which is set in “TargetApp” and “Target”, and sets the subsequent “document approval app” as the parameter value of “TargetApp” and “SetupWizardFinished” as the parameter value of “Target”. FIG. 8 illustrates an example setting of the edited service setting information.

Then, the process returns to step S102, and the license management app invokes a document approval app whose identifier is “document approval app”, which is set in the parameter name “TargetApp” (step S102). Since “SetupWizardFinished” has been set in “Target” (YES in step S103), the document approval app displays the completion of the setup wizard to notify the user that the environment setting of the service application has been completed (step S107).

In this exemplary embodiment, as described above, after having been invoked from the immediately preceding application (service application or common app), a common app performs the setting of items in a way similar to that in the existing procedure, changes a button to be displayed thereafter, edits service setting information, and then invokes the next application (service application or common app). In the manner described above, the process proceeds between common apps in accordance with service setting information. Thus, a service application does not need to perform any processing but is only required to invoke a common app set in the parameter name “TargetApp” defined in the service setting information until the setting of all the items has been completed.

In this exemplary embodiment, particularly, common apps are not allowed to set all its configurable items. For example, the service application “document approval app” in the service providing apparatus 10 uses only a domain name system (DNS) server. Thus, the user (or customer engineer) knows information concerning the DNS server, for example, the IP address, whereas the user has no knowledge about information on the proxy server and the like. When the common app “specification setting app” is selected to perform the setting of the DNS server, in the related art, the “specification setting app” performs not only DNS server setting but also proxy server setting and other setting. That is, in the related art, the “specification setting app” prompts the user to enter unnecessary items, such as the IP address of the proxy server.

In this exemplary embodiment, in contrast, as described above, the common app “specification setting app” requests the user to enter only the setting items for the “DNS server setting”. This allows the user to perform environment setting for a service application without getting annoyed about unexpected input.

A variety of modifications which may be made to the basic operation of this exemplary embodiment described above will now be described.

If a common app knows of a relationship of dependence in the setting order (precondition), the common app rearranges, at its discretion, the setting order defined in the service setting information. For example, the license registration employs an external server. Thus, a DNS server setting is performed before the license registration. However, because of the generation of the service setting information illustrated in FIG. 9, the license management app has been invoked first by the document approval app.

In this case, the license management app changes the setting order to that illustrated in FIG. 5, and then invokes the specification setting app in accordance with the content set in the service setting information. The specification setting app executes the process in the way described above in accordance with the service setting information illustrated in FIG. 5.

Because of the generation of the service setting information illustrated in FIG. 9, furthermore, the license management app invoked first from the document approval app generates service setting information illustrated by way of example in FIG. 10 and invokes the document approval app in order to inform the document approval app that the setting order is not correct (i.e., a DNS server setting should be performed prior to license registration). That is, the license management app sets “SetupWizardFinished_InvalidOrder” for the parameter name “Target” to indicate that the setting order defined in the service setting information is incorrect, and sets a common app and a setting item that should have been invoked first for “mustBeFirstApp” and “mustBeFirstTarget”, respectively. As will be understood, the application to be invoked by the license management app is an application set in nextAppα (α=1, 2, . . . ) (in the illustrated example, α=2), which is paired with nextTargetα in which “SetupWizardFinished” is set.

Upon receipt of the service setting information, the application (in the illustrated example, the “document approval app”) refers to the parameter value of the parameter name “Target” to know that the setting order defined in the service setting information is incorrect. Then, the document approval app refers to the parameter values of “mustBeFirstApp” and “mustBeFirstTarget” and modifies the service setting information. The result of modification is the same as that illustrated in FIG. 5. In some cases, persons having privileges for configuring settings in environment setting may differ. For example, a customer engineer who is in charge of performing environment setting is able to set specification settings but is not allowed to exercise a license that a customer has purchased. That is, only the customer who possesses the license is able to implement license registration. There is thus a need to change the person who performs operation to complete the environment setting. In this exemplary embodiment, when the environment setting process proceeds to the setting of an item for which specific privileges are required, the following process is performed to change the person who performs an environment setting operation.

For example, a setup wizard is executed in accordance with the service setting information illustrated in FIG. 5, and license registration is only allowed for the customer's system administrator. In this case, as described above, the specification setting app performs the setting of an item assigned thereto, and edits the service setting information to that illustrated in FIG. 7. Thereafter, the specification setting app invokes the license management app to be executed next. For example, upon detecting that a customer engineer who has no privileges is performing an operation on the basis of the login user's name prior to step S104, the license management app displays an operator change instruction screen illustrated by way of example in

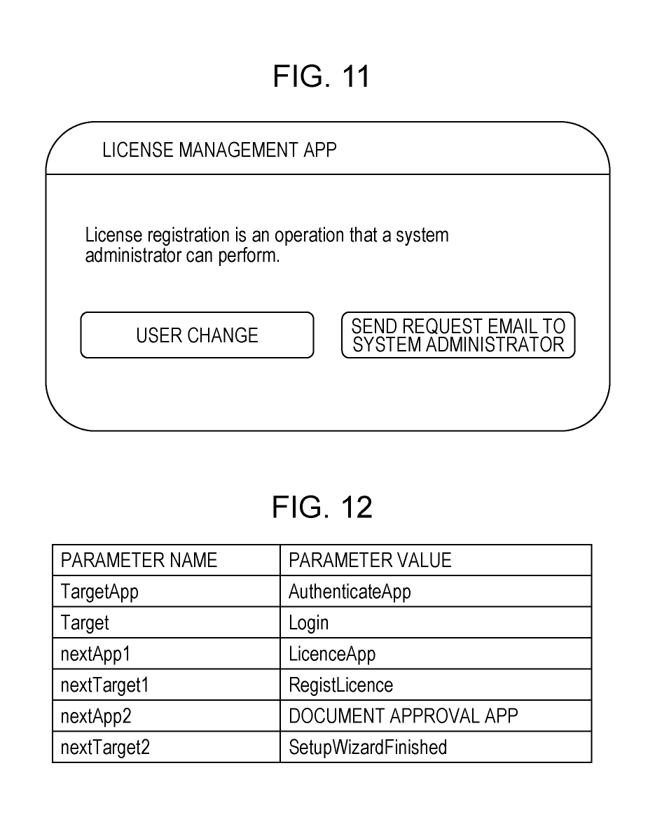

FIG. 11.

The customer engineer views the operator change instruction screen and calls a system administrator who has privileges in order to change the operator. When the system administrator selects a “User Change” button on the operator change instruction screen, the license management app generates service setting information illustrated by way of example in FIG. 12, and invokes an authentication app whose app identifier is “AuthenticateApp”. After performing user authentication of the system administrator who is now the operator, as described above, the authentication app deletes the parameter values for the process performed thereby, and edits the service setting information so that the subsequent parameter values move up. Consequently, the authentication app generates the service setting information illustrated in FIG. 7, and invokes the license management app in accordance with the content set in the generated service setting information. Accordingly, an item setting process using the license management app is started.

In contrast, when the customer engineer selects a “Send Request Email to System Administrator” button on the operator change instruction screen, the license management app converts the parameters in the service setting information illustrated in FIG. 7 into a URL, creates an email including the URL in its message body, and transmits the email to the system administrator. The email address of the system administrator is assumed to be set in the service providing apparatus 10 in advance. The email may include a message for notifying the system administrator of the purpose of the email, such as “Please implement license registration for the setup of the difference app”.

When the system administrator selects the URL in the email message, the authentication app is invoked. The authentication app performs user authentication of the system administrator in the way described above. Then, the process proceeds to the license management app, and the setting of the items to be set is performed.

In this exemplary embodiment, as described above, the operator who performs environment setting (i.e., an operator of the setup wizard) is changed during the environment setting.

In some cases, the setting of a setting item may be skipped during the execution of a setup wizard due to some reason such as an unclear item value to be entered. In this case, the user selects a “Set Later” button on the screen during the environment setting to skip the setting of the corresponding item. The common app in progress may convert parameters for the setting of the corresponding item into a URL and place a shortcut of the URL on the portal screen to facilitate later implementation of the setting of the skipped item. At later time, the user selects the shortcut to perform the setting of the skipped item.

If the setting of multiple items is skipped, a single shortcut may be created as a wizard for a list of the skipped items. In this case, the service setting information generation processing unit 11 may generate service setting information as service setting information for post-setting on the basis of the skipped setting items. Alternatively, the common app that is executed last may generate service setting information as service setting information for post-setting.

In other cases, an item to be set for the environment setting of a certain service has already been set during the environment setting of another service for which environment setting has been previously performed. In this manner, in a case where a certain item has already been set, that is, in a case where the settings for a certain item are present, a common app may check in advance the state of the setting of an item to be set. If the setting of the item has been completed, the common app may invoke the subsequent common app without displaying a user interface such as an input screen for setting the item.

As illustrated in, for example, FIG. 5, the service setting information contains pairs each including a common app and a setting item to specify items to be set. As described above, a single common app may be used to set multiple items. The setting of such items assigned to a single common app may be performed non-consecutively. In this case, a common app which is about to execute a process in accordance with the content set in the service setting information may collectively perform the setting of items including the current item and any subsequent items which are assigned to the common app, while ignoring the setting order defined in the service setting information. It is to be understood that, also in this case, no violation of the condition of the relationship of dependence in the setting order described above is required.

The modifications described above may be used in combination with or in place of the basic operation according to the exemplary embodiment. The modifications may be used in combination as desired.

In the exemplary embodiment, as described above, service setting information is used to request a user to enter only an item to be set. A service application that is not a common app will not perform any processing, merely by invoking the first common app in accordance with the content set in the service setting information, until the service application is invoked by the last common app. That is, the cooperative operation of common apps, the editing of service setting information, and other operations described above are fundamentally implemented between common apps.

In the exemplary embodiment, a service providing apparatus has been described in the context of a computer such as a PC. As an alternative, the service providing apparatus may be an image forming apparatus such as a multifunction device having multiple service functions and configured to provide users with services.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A service providing apparatus comprising:
a generator that generates service setting information, the service setting information including one or more applications that perform environment setting for a service selected by a user, an item to be set by each of the one or more applications for the environment setting of the service among items configurable by the application, and a setting order in which the one or more applications perform setting; and
a controller that controls display of a setting screen for the environment setting performed by the application in accordance with content set in the service setting information.

2. The service providing apparatus according to claim 1, wherein the controller requests the user to enter the item to be set through the setting screen.

3. The service providing apparatus according to claim 1, wherein in a case where the item to be set for the environment setting of the service has been set, the controller causes a process to proceed to a subsequent application in the setting order.

4. The service providing apparatus according to claim 1, wherein the controller has a function of skipping setting of the item to be set for the environment setting of the service.

5. The service providing apparatus according to claim 4, further comprising a unit that generates service setting information as service setting information for post-setting by using the item to be set for which the setting has been skipped by the controller,
wherein the controller performs environment setting for the service in accordance with content set in the service setting information for post-setting.

6. A non-transitory computer readable medium storing a program causing a computer to execute a process, the process comprising:
generating service setting information, the service setting information including one or more applications that perform environment setting for a service selected by a user, an item to be set by each of the one or more applications for the environment setting of the service among items configurable by the application, and a setting order in which the one or more applications perform setting; and
controlling display of a setting screen for the environment setting performed by the application in accordance with content set in the service setting information.

7. A service providing method comprising:
generating service setting information, the service setting information including one or more applications that perform environment setting for a service selected by a user, an item to be set by each of the one or more applications for the environment setting of the service among items configurable by the application, and a setting order in which the one or more applications perform setting; and
controlling display of a setting screen for the environment setting performed by the application in accordance with content set in the service setting information.
